(19) United States
(12) Patent Application Publication
(10) Pub. No.: US 2007/0266360 A1
(43) Pub. Date: Nov. 15, 2007

(54) Metal Thickness Simulation for Improving RC Extraction Accuracy

(75) Inventors: Yi-Kan Cheng, Taipei (TW); Ke-Ying Su, Hsinchu City (TW); Victor C. Y. Chang, Hsinchu City (TW)

Correspondence Address: HAYNES AND BOONE, LLP, 901 MAIN STREET, SUITE 3100, DALLAS, TX, 75202, US

(73) Assignee: TAIWAN SEMICONDUCTOR MANUFACTURING COMPANY, LTD., Hsin-Chu (TW)

(21) Appl. No.: 11/688,692

(22) Filed: Mar. 20, 2007

Related U.S. Application Data
(60) Provisional application No. 60/800,526, filed on May 15, 2006.

(51) Int. Cl. G06F 17/50

(52) U.S. Cl. 716/11

(57) ABSTRACT

An integrated circuit (IC) design method includes providing a design layout defined in a plurality of grids; simulating a chemical mechanical polishing (CMP) process to an IC substrate with a patterned structure defined by the design layout, generating a dielectric thickness and a metal thickness on one of the plurality of grids; extracting a capacitance based on the dielectric thickness on the one of the plurality of grids; and extracting a resistance based on the metal thickness on the one of the plurality of grids.

### CROSS-REFERENCE

This application claims the benefit of U.S. Provisional Application 60/800,526 entitled “Design for Manufacturability,” filed May 15, 2006, incorporated herein by reference in its entirety. The present disclosure is related to the following commonly-assigned U.S. patent applications, the entire disclosures of which are hereby incorporated herein by reference: U.S. patent application by inventors Gwan Sin Chang, Yi-Kan Cheng, Ivy Chiu, and Ke-Ying Su for “IC DESIGN FLOW ENHANCEMENT WITH CMP SIMULATION” (attorney reference TSMC2006-0378).

### BACKGROUND

Semiconductor technologies are continually progressing to smaller feature sizes, such as 65 nanometers, 45 nanometers, and below. Integrated circuits (IC) fabrication technologies have been exploited to a limit and need more interactions between manufacturing and designing.

One such limit relates to metal thickness. Current IC design flow only considers ideal or simplified models for metal thickness substitution. The current method for signal analysis and design performance evaluation cannot reflect the variations in metal thickness that actually occur during fabrication. For example, in the current design flow, the IC design layouts have no proper way to connect to and incorporate with a chemical mechanical polishing (CMP) process. However, the variations of the metal thickness from the CMP process seriously impacts the signal wire characteristics, IC design functionality, and performance. For various environments, the same metal wire may have different thicknesses due to the CMP process, which results in variations of electrical properties of the signal wire.

### BRIEF DESCRIPTION OF THE DRAWINGS

Aspects of the present disclosure are best understood from the following detailed description when read in association with the accompanying figures. It is noted that, in accordance with the standard practice in the industry, various features in the drawings are not drawn to scale. In fact, the dimensions of illustrated features may be arbitrarily increased or decreased for clarity of discussion.

FIG. 1 is a block diagram illustrating one embodiment of a design for manufacturing (DFM) system constructed according to aspects of the present disclosure.

FIG. 2 is a flowchart of one embodiment of RC extraction integrated with chemical mechanical polishing (CMP) process simulation constructed according to aspects of the present disclosure.

FIG. 3 is a top view of an integrated circuit (IC) substrate in one embodiment, constructed according to aspects of the present disclosure.

FIG. 4 is a sectional view of one embodiment of an IC substrate constructed according to aspects of the present disclosure.

FIG. 5 is a sectional view of another embodiment of an IC substrate constructed according to aspects of the present disclosure.

FIG. 6 is a sectional view of another embodiment of an IC substrate constructed according to aspects of the present disclosure.

FIG. 7 is an illustration of a computer system for implementing one or more embodiments of the present invention.

### DETAILED DESCRIPTION

It is understood that the following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Design for manufacturability, or DFM, is an integration of manufacturing data and design procedure for better yield and design efficiency. An interaction and communication between designer and manufacturer is enhanced thereby for more accurate, faster, and more efficient design. In one example, various manufacturing data are formulated, quantified, and integrated to enable collaboration between manufacturer and designer, reduce design time and design cost, and increase manufacturing yield and production performance. DFM can be realized at various design stages with collaboration of design tool vendors. The manufacturer may be a semiconductor foundry. The designer may be an integrated circuit (IC) design house. The design tool vendor may be an electronic design automation (EDA) tool vendor. In some examples, a single company may include all three.

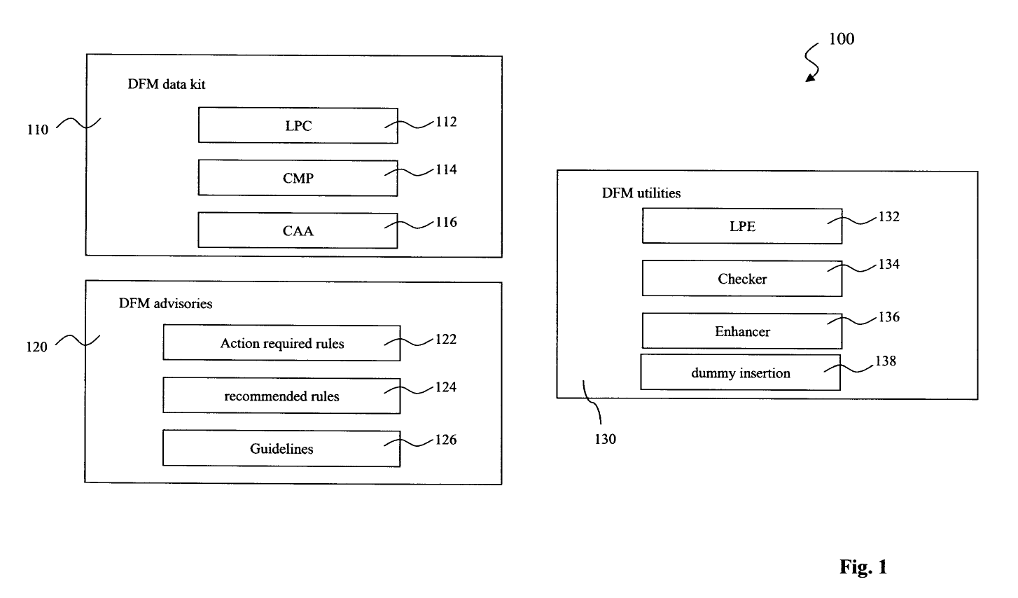

Referring to FIG. 1, an embodiment of a DFM (or DFM tool kit) 100 in a block diagram may include one or more various modules. In the present embodiment, the DFM 100 includes a DFM data kit (DDK) 110. Manufacturing data, such as processing recipes, tool characterization, manufacturing environment, production and processing statistical information, and IC testing and measurement data, are compiled, accumulated, and formulated to form the DDK and provide a manufacturing simulation such as lithography process check (LPC) simulation 112, chemical mechanical polishing (CMP) simulation 114, and/or critical area analysis (CAA) simulation 116. In LPC simulation 112, a lithography process can be simulated for a design layout by implementing DDK. Various failure areas, defect areas, or weak areas associated with the manufacturing process, referred to as hotspots, can be identified for further design tuning.

In the CMP simulation 114, a CMP process is simulated to a design layout by utilizing DDK 110. The design layout is converted to a material thickness and thickness hotspots can be identified for further design tweaking and tuning. CAA simulation 116 utilizes DDK for critical area identification and design improvement. DFM data may be packed in a unified format, referred to as DFM unified format (DUF). DDK 110 can be provided to an IC design vendor and be integrated into a design tool, or directly distributed to a designer such as a fab-less design house and employed by the designer in a design tool.

DFM 100 also includes DFM advisories 120. The DFM advisories 120 are extracted from the manufacturing information and provided for an IC design tool and/or a designer. The DFM advisories 120 further include DFM rules that can be incorporated into a design tool for checking any violation. DFM rules such as action required rules 122 are binding, requiring further actions to eliminate the associated violation. Recommended rules 124 are not binding and suggested for design improvement. The DFM advisories also include guidelines 146, provided for the designer to follow in implementing an IC design procedure.

DFM 100 also includes DFM utilities 130, utilizing DDK 110 and DFM advisories 120 in IC design. DFM utilities 130 may be integrated into a design tool and incorporated into a design flow. For example, dummy insertion may be implemented at the place-and-route design stage so that dummy features are automatically generated in the IC layout to reduce CMP manufacturing variances. DFM utilities 130 may provide corrective actions and solutions to the designer to guide for design improvement and tuning. For example, DFM utilities 130 may provide a solution to eliminate identified hotspots from a lithography process simulation, such as reconfiguring metal lines to eliminate the hotspots. In one embodiment, DFM utilities 130 include a layout parasitic extraction (LPE) deck 132 for extracting more accurate parasitic parameters such as parasitic resistance and capacitance with the manufacturing data such as CMP data, and further for providing suggested actions to adjust parasitic parameters and timing. DFM utilities 130 may also include a checker 134 that is integrated with DFM rules, is able to automatically check the layout for any DFM rule violation, and/or provides suggestions to eliminate the violation. DFM utilities 130 may include an enhancer 136 that is capable of automatically adjusting the layout to meet the DFM rules or eliminate identified hotspots. DFM utilities 130 may further include a dummy insertion module 138 to incorporate dummies (e.g., non-conducting metal features) into a design layout to eliminate CMP process variation.

DFM 100 provides model-based utilities from various simulations and rule-based utilities from DFM advisories. DFM 100 can be implemented at various designing stages and certain manufacturing stages. For example, dummy insertion may be implemented at place-and-route step such that the dummy features are included in a layout at early design stage. LPE deck may be implemented at extraction and a timing simulation. LPC may be implemented before the tape-out. Alternatively, LPC may be implemented after the tape-out. In this situation, the layout can be adjusted to eliminate hotspots identified by LPC before fabricating a mask of the layout in a mask shop.

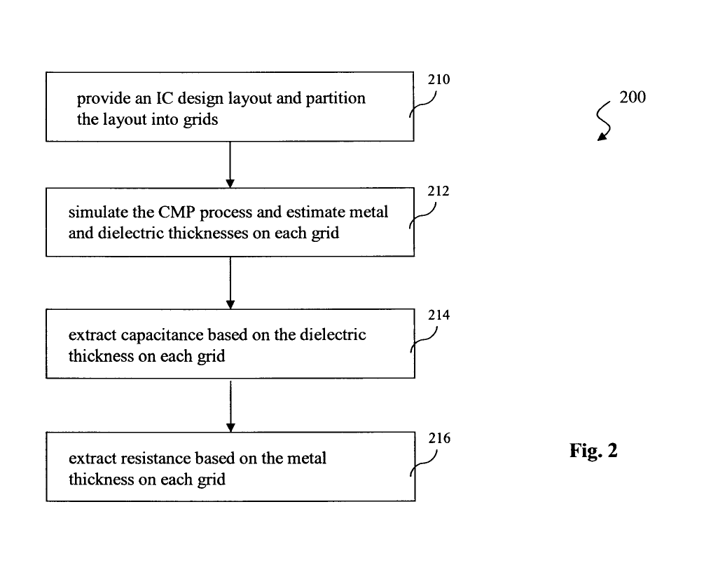

FIG. 2 is a flowchart of an IC design method 200 utilizing a virtual CMP (VCMP) and resistance/capacitance (RC) extraction tool integrated and incorporated into various steps thereof, with various functions and mechanism. A design system to implement the method 200 is described collectively. The VCMP and RC extraction are integrated to guide IC design for accurate parasitic RC extraction and enhanced, efficient IC design.

The method begins at step 210 by providing an IC design layout defined into a plurality of grids. The IC design layout may include physical design information in certain layer(s) and may come from a product specification through various design stages such as logic design, floor plan, and place and route. The design module for implementing the above logic and physical design processes may include an RTL/synthesis, and place & route.

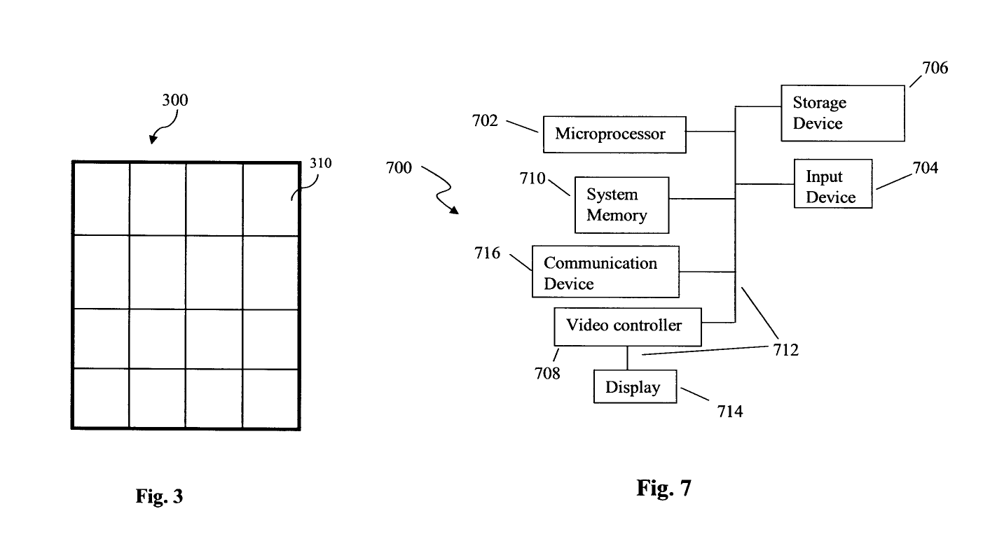

Referring also to FIG. 3, an IC design layout is also partitioned into a plurality of grids as illustrated. An integrated circuit (IC) substrate 300 can be a portion of a semiconductor wafer. For example, the substrate 300 is a die area where the IC design layout is to be formed on. The design layout is portioned properly into a plurality of grids such as a grid 310. The plurality of grids may have the same dimensions, defined according predetermined rules for both efficiency and effectiveness of the following CMP simulation.

The design method 200 (FIG. 2) proceeds to step 212 for simulating a CMP process and estimating a metal thickness and a dielectric thickness on each defined grid. A VCMP module is designed for CMP simulations. The VCMP module adopts a model to describe a CMP process and further includes the CMP manufacturing data to simulate a real manufacturing CMP process. The CMP manufacturing data may include CMP tool characterization data, CMP slurry and other chemicals characterization data, and CMP processing recipes.

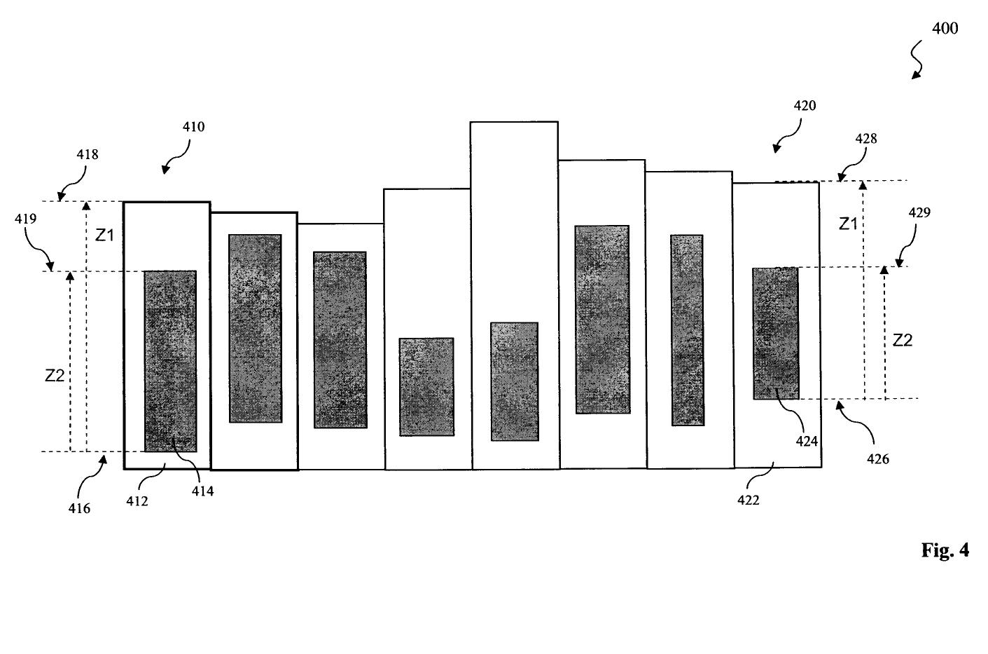

Referring to FIG. 4, based on the CMP simulation, the dielectric thickness and metal thickness are estimated on each grid. An IC substrate 400 with an exemplary interconnect structure constructed according to a pre-designed circuit such as the IC design layout and formed by a CMP simulation is shown. The metal and dielectric layers have different thicknesses on each local region due to the real manufacturing CMP process simulated hereby. The substrate 400 includes various interconnect regions such as regions 410 and 420. The interconnect region 410 includes dielectric material 412 and a metal features 414 formed in the dielectric material 412. The interconnect region 420 includes dielectric material 422 and a metal features 424 formed in the dielectric material 422. For each interconnect structure, a dielectric height is defined as a vertical distance “Z1” from the metal bottom (or trench bottom) to the top surface of the dielectric material. A metal height is defined as a vertical distance “Z2” from the metal bottom to the top surface of the metal feature. Take the interconnect structure 410 as an example, the dielectric height Z1 is defined as the vertical distance from the trench bottom 416 to the top surface 418 of the dielectric material. The metal height Z2 is defined as a vertical distance from the trench bottom 416 to the top surface 419 of the metal feature. Similarly, for the interconnect structure 420, the dielectric height Z1 is defined as the vertical distance from its trench bottom 426 to the top surface 428 of the dielectric material. The metal height Z2 is defined as a vertical distance from the trench bottom 426 to the top surface 429 of the metal feature. Thus the dielectric height and metal height are estimated based on the CMP simulation results. In one embodiment, each interconnect feature in FIG. 4, such as 410 or 420, is defined as one grid of the corresponding IC design layout. The dielectric height Z1 for all grids corresponding to the IC design layout can be saved into one file further processing. Similarly, the metal height Z2 for all grids corresponding to the IC design layout can be saved into another file further processing.

The metal thickness and dielectric thickness can be easily extracted from the metal height and dielectric height. For example, the metal thickness is Z1 and dielectric thickness is the difference between Z1 and Z2 for that grid. In one embodiment, the above simulation and extraction are based on one layer mode where only one structure layer, such as metal one layer, is considered for CMP simulation parameter extraction. The impacts of the underlying structure layers to the overlying layer in term of CMP process is neglected for simplicity.

In another embodiment, the simulation and extraction are based on a multilayer mode where only multiple structure layers are considered for CMP process and simulation since a stacking effect can substantially impact the CMP and final surface topography.

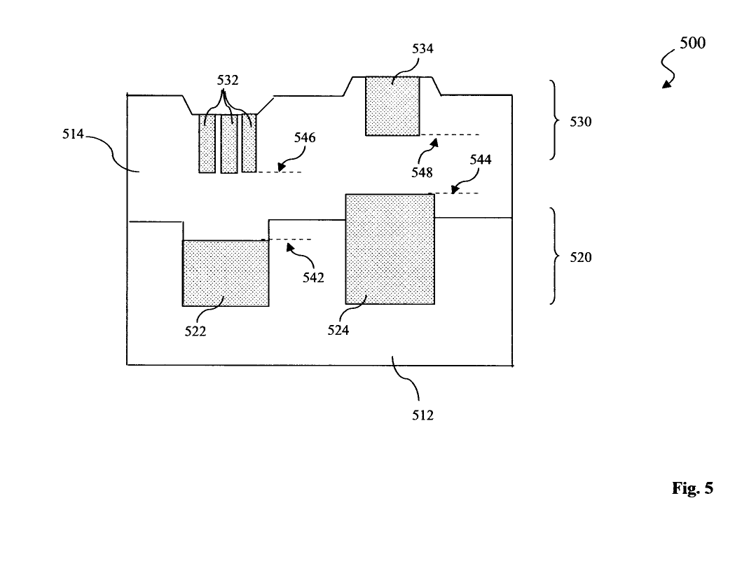

Referring to FIG. 5, the stacking effect and multilayer mode is described with reference to an exemplary IC substrate 500 having at least two metal layers. The substrate 500 include dielectric layers 512 and 514. The substrate 500 also includes an underlying metal layer 520 (such as metal one in one example). The underlying metal layer 520 includes exemplary metal features 522 and 524. The substrate 500 also includes an overlying metal layer 530 (such as metal two in one example). The overlying metal layer 530 includes exemplary metal features 532 and 534. In this exemplary configuration, the metal feature 532 is overlying the metal feature 522. The metal feature 534 is overlying the metal feature 524. The underlying metal layer 520 has an uneven surface. Metal feature 522 has a top surface 542 lower than the top surface 544 of the metal feature 524. Accordingly, the metal feature 532 has a metal bottom 546 lower than the metal bottom 548 of the metal feature 534. This uneven topography will pass from an underlying layer to an overlying layer, and is accumulated and passed to higher layer. This phenomena is referred to as the stacking effect. In multilayer CMP simulation mode, stacking effect is included and multiple layers are collectively considered in simulating a CMP process to one overlying layer. One additional parameter is needed for this purpose and is described below.

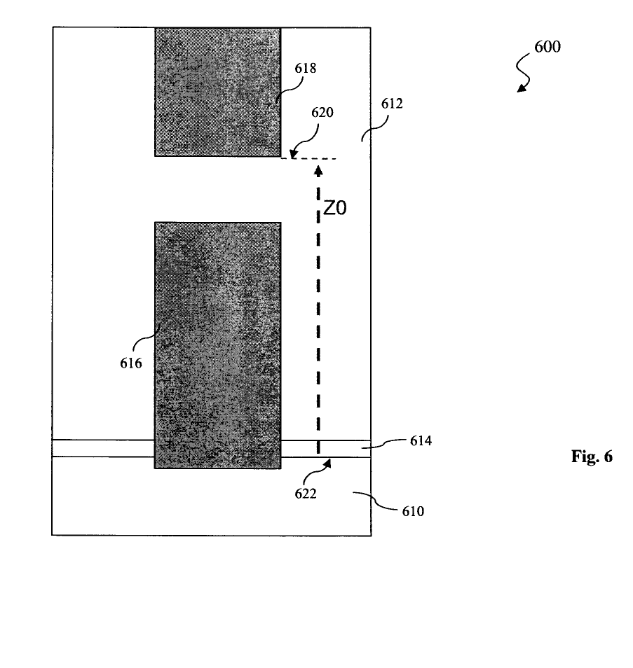

Referring to FIG. 6, in this consideration, when the metal bottom (or trench bottom) is used as a relative reference, an absolute height of each metal bottom is fully defined and extracted. FIG. 6 is a sectional view of another embodiment of an IC substrate 600 constructed according to aspects of the present disclosure. The substrate 600 includes dielectric layers 610 and 612, and an etch stop layer (ESL) 614. The substrate 600 also includes an underlying metal layer with exemplary metal feature 612. In one example, the underlying metal layer is a metal one layer. The substrate 600 also includes an overlying metal layer with an exemplary metal feature 618. The overlying metal layer can be metal two, metal three, or other high metal layers in various examples. For the CMP simulation of the overlying metal layer, the metal bottom of the overlying metal feature 618 is defined with a generic reference.

In one example, the ESL 614 is used as the generic reference. Therefore, the absolute height Z0 of the metal bottom 620 of the metal feature 618 is defined as a vertical distance from the ESL 614 to the metal bottom 620. Specifically in one example, the absolute height Z0 is defined as a vertical distance from the ESL bottom 622 to the metal bottom 620. When each metal bottom is used as a local reference for dielectric height Z1 and metal height Z2, its absolute vertical location is also defined as Z0 to the ESL 612 in the metal one layer. Thus the absolute dielectric height and metal height for each metal layer in each grid can be included in the CMP simulation. The stacking effect is therefore included in the multilayer CMP simulation mode. The parameters Z0, Z1, and Z2 are essential to for accurate three dimensional RC extraction.

The disclosed RC extraction method not only includes CMP simulation but also three dimensional RC extraction. The disclosed RC extraction method is capable for more accurately simulate CMP processes and estimate dielectric and metal parameter for multiple interconnect structure.

Referring again to FIG. 2, the IC design method 200 proceeds to step 214 for extracting capacitance and step 216 for extracting resistance to the corresponding design layout based on the local dielectric and metal thicknesses on each grid generated from the CMP simulation. For example, the parasitic capacitance for a certain layer in one grid can be determined by the dielectric thickness and metal areas of the adjacent metal features above and below. In doing so, other parameters such as the metal width may be obtained from the existing design tool such as SPICE. SPICE is an example of a tool to provide complete physical simulation including output signal deformation, signal level, and time delay, developed by UC Berkeley. Another alternative tool is ASTAP developed by IBM.

The IC design method 200 may further include other modules. For example, the IC design method 200 can include a timing analyzer for signal timing analysis based on the extracted parasitic capacitance and resistance.

The IC design method 200 may further include a front-end design step before the physical layout design, such as a register-transfer level (RTL) design. The design method 200 may also include floor planning and place-and-route. Standard cells, input/output (I/O) cells, and IP/Macro can be placed in various locations according to the functional connectivity and the optimization of signal routing.

The design method 200 may also include design rule check (DRC) and layout vs. schematic (LVS). DRC is performed on the physical layout to verify that the manufacturer concerned process requirements have been satisfied. LVS is performed such that the devices/interconnects are extracted to generate a netlist for comparison with an original design netlist. The design method 200 may also include other steps such as dummy insertion.

The design method 200 may include a tape-out step to form a final IC design presented as various photomask patterns. After the verifications of design functional specification, signal timing, device connectivity, and design rule of layout are accomplished, the layout will be taped out and be provided to a manufacturer, such as a semiconductor foundry for fabrication.

Referring now to FIG. 7, shown therein is an illustrative computer system 700 for implementing embodiments of the methods described above. Computer system 700 includes a microprocessor 702, an input device 704, a storage device 706, a video controller 708, a system memory 710, and a display 714, and a communication device 716 all interconnected by one or more buses 712. The storage device 706 could be a floppy drive, hard drive, CD-ROM, optical drive, or any other form of storage device. In addition, the storage device 706 may be capable of receiving a floppy disk, CD-ROM, DVD-ROM, or any other form of computer-readable medium that may contain computer-executable instructions. Further communication device 716 could be a modem, network card, or any other device to enable the computer system to communicate with other nodes. It is understood that any computer system could represent a plurality of interconnected (whether by intranet or Internet) computer systems, including without limitation, personal computers, mainframes, PDAs, and cell phones.

A computer system typically includes at least hardware capable of executing machine readable instructions, as well as the software for executing acts (typically machine-readable instructions) that produce a desired result. In addition, a computer system may include hybrids of hardware and software, as well as computer sub-systems.

Hardware generally includes at least processor-capable platforms, such as client-machines (also known as personal computers or servers), and hand-held processing devices (such as smart phones, personal digital assistants (PDAs), or personal computing devices (PCDs), for example). Further, hardware may include any physical device that is capable of storing machine-readable instructions, such as memory or other data storage devices. Other forms of hardware include hardware sub-systems, including transfer devices such as modems, modem cards, ports, and port cards, for example.

Software includes any machine code stored in any memory medium, such as RAM or ROM, and machine code stored on other devices (such as floppy disks, flash memory, or a CD ROM, for example). Software may include source or object code, for example. In addition, software encompasses any set of instructions capable of being executed in a client machine or server.

Combinations of software and hardware could also be used for providing enhanced functionality and performance for certain embodiments of the present disclosure. One example is to directly manufacture software functions into a silicon chip. Accordingly, it should be understood that combinations of hardware and software are also included within the definition of a computer system and are thus envisioned by the present disclosure as possible equivalent structures and equivalent methods.

Computer-readable mediums include passive data storage, such as a random access memory (RAM) as well as semi-permanent data storage such as a compact disk read only memory (CD-ROM). In addition, an embodiment of the present disclosure may be embodied in the RAM of a computer to transform a standard computer into a new specific computing machine.

Data structures are defined organizations of data that may enable an embodiment of the present disclosure. For example, a data structure may provide an organization of data, or an organization of executable code. Data signals could be carried across transmission mediums and store and transport various data structures, and, thus, may be used to transport an embodiment of the present disclosure.

The system may be designed to work on any specific architecture. For example, the system may be executed on a single computer, local area networks, client-server networks, wide area networks, internets, hand-held and other portable and wireless devices and networks.

A database may be any standard or proprietary database software, such as Oracle, Microsoft Access, SyBase, or DBase II, for example. The database may have fields, records, data, and other database elements that may be associated through database specific software. Additionally, data may be mapped. Mapping is the process of associating one data entry with another data entry. For example, the data contained in the location of a character file can be mapped to a field in a second table. The physical location of the database is not limiting, and the database may be distributed. For example, the database may exist remotely from the server, and run on a separate platform. Further, the database may be accessible across the Internet. Note that more than one database may be implemented.

Thus, the present disclosure provides an integrated circuit (IC) design method. The method includes providing a design layout defined in a plurality of grids; simulating a chemical mechanical polishing (CMP) process to an IC substrate with a patterned structure defined by the design layout, generating a dielectric thickness and a metal thickness on one of the plurality of grids; extracting a capacitance based on the dielectric thickness on the one of the plurality of grids; and extracting a resistance based on the metal thickness on the one of the plurality of grids.

In the disclosed IC design method, the providing of the design layout may include partitioning the design layout into the plurality of grids. The providing of the design layout may include forming a logic design; and forming the design layout based on the logic design. The simulating of the CMP process may include simulating the CMP process in single layer mode. The simulating of the CMP process may include simulating the CMP process in multilayer mode. The simulating of the CMP process in multilayer mode may include incorporating a stacking effect. The simulating of the CMP process may include utilizing data selected from the group consisting of CMP processing recipes, CMP tool characterization, manufacturing environment, production and processing statistical information, and combinations thereof. The simulating of the CMP process may include defining a dielectric surface height and a metal surface height relative to a trench bottom on the one of the plurality of grids. The generating of the dielectric thickness and the metal thickness may include utilizing the dielectric surface height and the metal surface height. The simulating of the CMP process may include defining a height of the trench bottom relative to an absolute reference. The absolute reference may be defined as an etch stop layer disposed in a first metal structure. The generating of the dielectric thickness and the metal thickness may include utilizing the dielectric surface height, the metal surface height, and the height of the trench bottom in a multilayer mode.

The present disclosure also provides another embodiment of an integrated circuit (IC) design method. The method includes generating a design layout; defining the design layout into a plurality of grids; simulating a chemical mechanical polishing (CMP) process to an IC substrate with a patterned structure defined by the design layout; extracting a dielectric thickness and a metal thickness on one of the plurality of grids based on the simulating of the CMP process; extracting a capacitance based on the dielectric thickness on the one of the plurality of grids; and extracting a resistance based on the metal thickness on the one of the plurality of grids.

In this disclosed method, the extracting of the dielectric thickness and metal thickness may include utilizing a single layer mode or a multilayer mode. The IC design method may further include a timing analysis after the extracting of the capacitance and the extracting of the resistance.

The present disclosure also includes an IC design system. The IC design system includes a design module being capable of providing a design layout; and a resistance and capacitance (RC) extractor. The RC extractor is designed for defining the design layout into a plurality of grids; simulating a chemical mechanical polishing (CMP) process; generating a metal thickness and a dielectric thickness on each of the plurality of grids corresponding to the design layout; and extracting a resistance and a capacitance on the each of the plurality of grids.

The disclosed IC design system may further include a timing analyzer for performing timing analysis to the design layout based on the resistance and capacitance extracted by the RC extractor. The IC design system may further include at least one of CMP layout guidelines and suggested structures for fixing CMP hotspots. The IC design system may further include a design-for-manufacturing (DFM) data kit having various CMP processing data. The various CMP processing data may include those selected from the group consisting of CMP processing recipes, CMP tool characterization, manufacturing environment, production and processing statistical information, and combinations thereof.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments disclosed herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. An integrated circuit (IC) design method, comprising:
providing a design layout defined in a plurality of grids;
simulating a chemical mechanical polishing (CMP) process to an IC substrate with a patterned structure defined by the design layout, the simulation generating a dielectric thickness and a metal thickness on at least one of the plurality of grids;
extracting a capacitance based on the dielectric thickness on the at least one of the plurality of grids; and
extracting a resistance based on the metal thickness on the at least one of the plurality of grids.

2. The IC design method of claim 1, wherein providing the design layout comprises partitioning the design layout into the plurality of grids.

3. The IC design method of claim 1, wherein providing the design layout comprises:
forming a logic design; and
forming the design layout based on the logic design.

4. The IC design method of claim 1, wherein simulating the CMP process comprises simulating the CMP process in a single layer mode.

5. The IC design method of claim 1, wherein simulating the CMP process comprises simulating the CMP process in a multilayer mode.

6. The IC design method of claim 5, wherein simulating the CMP process in multilayer mode comprises incorporating a stacking effect.

7. The IC design method of claim 1, wherein simulating the CMP process comprises utilizing data selected from the group consisting of CMP processing recipes, CMP tool characterization, manufacturing environment, production and processing statistical information, and combinations thereof.

8. The IC design method of claim 1, wherein simulating the CMP process comprises defining a dielectric surface height and a metal surface height relative to a trench bottom on the one of the plurality of grids.

9. The IC design method of claim 8, wherein generating the dielectric thickness and the metal thickness comprises utilizing the dielectric surface height and the metal surface height.

10. The IC design method of claim 8, wherein simulating the CMP process comprises defining a height of the trench bottom relative to an absolute reference.

11. The IC design method of claim 10, wherein the absolute reference is defined as an etch stop layer disposed in a first metal structure.

12. The IC design method of claim 11, wherein generating the dielectric thickness and the metal thickness comprises utilizing the dielectric surface height, the metal surface height, and the height of the trench bottom in a multilayer mode.

13. The IC design method of claim 1, further comprising:
performing a timing analysis after the extracting of the capacitance and the extracting of the resistance.

14. An integrated circuit (IC) design system, comprising:
a design module being capable of providing a design layout; and
a resistance and capacitance (RC) extractor designed for:
defining the design layout into a plurality of grids;
simulating a chemical mechanical polishing (CMP) process;
generating a metal thickness and a dielectric thickness on each of the plurality of grids corresponding to the design layout; and
extracting a resistance and a capacitance on the each of the plurality of grids.

15. The IC design system of claim 14 further comprising:
a timing analyzer for performing timing analysis to the design layout based on the resistance and capacitance extracted by the RC extractor.

16. The IC design system of claim 14, further comprising at least one of CMP layout guidelines and suggested structures for fixing CMP hotspots.

17. The IC design system of claim 14, further comprising:
a design-for-manufacturing (DFM) data kit having various CMP processing data.

18. The IC design system of claim 17, wherein the various CMP processing data comprise those selected from the group consisting of CMP processing recipes, CMP tool characterization, manufacturing environment, production and processing statistical information, and combinations thereof.
